(19) United States
(12) Patent Application Publication
(10) Pub. No.: US 2025/0274557 A1
(43) Pub. Date: Aug. 28, 2025

(54) INFORMATION PROCESSING APPARATUS, CONTROL METHOD, AND STORAGE MEDIUM STORING PROGRAM

(71) Applicant: CANON KABUSHIKI KAISHA, Tokyo (JP)

(72) Inventor: KIMIO HAYASHI, Tokyo (JP)

(21) Appl. No.: 19/060,508

(22) Filed: Feb. 21, 2025

(30) Foreign Application Priority Data
Feb. 27, 2024 (JP) 2024-027872

(51) Int. Cl. H04N 1/60; G06K 15/02; H04N 1/00

(52) U.S. Cl. CPC H04N 1/6033; G06K 15/027; H04N 1/00323

(57) ABSTRACT

The information processing apparatus obtains information relating to colorimetry from a colorimeter connected to the information processing apparatus; and controls, the colorimeter to execute calibration, based on the obtained information relating to colorimetry.

### BACKGROUND

### Technical Field

The present disclosure relates to an information processing apparatus, a control method, and a storage medium storing a program that are capable of controlling a colorimeter.

### Description of the Related Art

In the case of using a colorimeter in order to perform colorimetry of a color chart in commercial printing, calibration of the colorimeter is performed before the colorimetry. Calibration of a colorimeter is processing for correcting a deviation between a reference value and a measured value of a white reference plate. As an operation for calibration, for example, for a manual colorimeter, the colorimeter is set on a white reference plate used for adjustment of the colorimeter, and a colorimetry button of the colorimeter is pressed and held, whereby the calibration of the colorimeter is performed. In general, calibration of a colorimeter is performed when the measurement mode has been changed or a certain amount of time has passed, or performed every time colorimetry of a color chart is performed.

Japanese Patent Laid-Open No. 2010-201819 describes that a patch for checking aging is printed on a margin of a color chart, and, if there is any difference between a reference value and a value obtained by performing colorimetry of the patch using a colorimeter installed inside an image forming apparatus, it is determined that calibration of a colorimeter is needed. The reference value is a value obtained by performing colorimetry of a color chart using a colorimeter at a timing immediately after purchase of the image forming apparatus, for example.

Japanese Patent Laid-Open No. 2010-201819 assumes a colorimeter installed in an image forming apparatus. Accordingly, measurement conditions such as a sheet, color processing, a measurement mode of the colorimeter, and an observation light source are always constant. Therefore, when the measurement conditions change depending on the use, such as in the case of an external colorimeter, it is not possible to correctly determine the necessity of calibration for the colorimeter.

### SUMMARY

The present disclosure provides an information processing apparatus, a control method, and a storage medium storing a program that allow calibration of an external colorimeter to be executed appropriately.

The present disclosure in one aspect provides a control method executed in an information processing apparatus, the method comprising: obtaining information relating to colorimetry from a colorimeter connected to the information processing apparatus; and controlling, the colorimeter to execute calibration based on the obtained information relating to colorimetry.

According to the present disclosure, it is possible to appropriately execute calibration of an external colorimeter.

Further features of the present disclosure will become apparent from the following description of exemplary embodiments with reference to the attached drawings.

### BRIEF DESCRIPTION OF THE DRAWINGS

FIG. 1 is a diagram showing a configuration of a system.

FIG. 2 is a diagram showing a configuration of an information processing apparatus.

FIG. 3 is a diagram showing a functional block configuration of the system.

FIGS. 4A and 4B are diagrams showing user interface screens.

FIGS. 5A and 5B diagrams showing user interface screens.

FIG. 6 is a diagram showing a colorimetric condition.

FIG. 7 is a diagram showing a color chart.

FIGS. 8A and 8B are flowcharts illustrating processing for controlling execution of calibration of a colorimeter.

FIGS. 9A and 9B are flowchart illustrating processing for controlling execution of calibration of the colorimeter.

FIG. 10 is a diagram showing a setting screen of an execution timing of calibration of the colorimeter.

FIGS. 11A and 11B are flowchart illustrating processing for controlling execution of calibration of the colorimeter.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made an disclosure that requires all such features, and multiple such features may be combined as appropriate. Furthermore, in the attached drawings, the same reference numerals are given to the same or similar configurations, and redundant description thereof is omitted.

According to the present disclosure, it is possible to appropriately execute calibration of an external colorimeter.

### First Embodiment

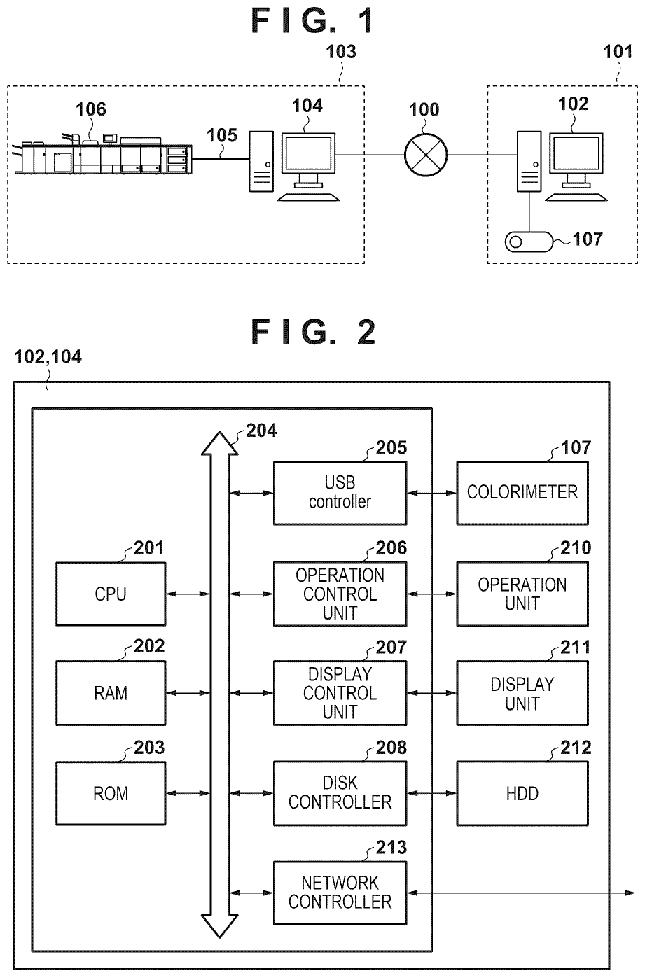

FIG. 1 is a diagram showing a configuration of a system according to the present embodiment. This system includes a colorimetric system 101 and a print system 103, which are connected to each other via the Internet 100. The colorimetric system 101 includes an information processing apparatus 102, and a colorimeter 107 connected to the information processing apparatus 102. For example, the information processing apparatus 102 includes an application capable of controlling the colorimeter 107. For example, the application instructs the colorimeter 107 to perform a setup, and receives a colorimetric result (colorimetric value) of a color chart obtained by the colorimeter 107. Such an application may be either an on-premises application or a cloud application. The colorimeter 107 may be either a manual colorimeter or an automatic colorimeter. In the print system 103, an information processing apparatus 104 and an image forming apparatus 106 are connected to each other by a network 105. An application that operates on the information processing apparatus 104 is mainly referred to as a print controller, and controls the image forming apparatus 106. The image forming apparatus 106 is controlled under a group of programs that operate on the information processing apparatus 104, processes print settings and print data that have been received from the information processing apparatus 104, and outputs a printed material.

In a system as shown in FIG. 1, a user (operator) can access the information processing apparatus 104 from the information processing apparatus 102, and remotely control execution of quality inspection such as color verification. For example, it may be envisaged that the following four steps are executed as quality inspection. In the first step, a test type is selected. For example, a color verification test may be selected. In the second step, a quality inspection apparatus (i.e., an image forming apparatus) capable of executing the selected test is selected. In the third step, quality inspection is executed. For example, colorimetry of a patch may be executed. In the fourth step, the quality inspection is completed. Although FIG. 1 shows a set of combination of an information processing apparatus and an image forming apparatus in the print system 103, there may be a plurality of sets of combination of information processing apparatuses and image forming apparatuses. Such an application that executes quality inspection such as color verification corresponds to, for example, an application that operates on the information processing apparatus 104 described above.

In the present embodiment, colorimetry for a color chart output from the image forming apparatus 106 can be performed in the vicinity of the information processing apparatus 102 that is located away from the image forming apparatus 106 and the information processing apparatus 104. The configuration of the present system is not limited to the configuration shown in FIG. 1, and may be a system for which connection is established via a network such as LAN or WAN to perform processing. The system may also be a system in which the information processing apparatus 102 and the information processing apparatus 104 are configured as a single device.

FIG. 2 is a block diagram showing an example of the configuration of the information processing apparatus 102. In FIG. 2, a CPU 201 executes a program of an OS or a general application that is stored in a ROM 203, or loaded from an HDD 212 to a RAM 202. The RAM 202 functions as a main memory, a work area, or the like of the CPU 201. A USB controller 205 receives an instruction to the colorimeter 107, and a colorimetric result (colorimetric value) from the colorimeter 107. An operation control unit 206 controls input from an operation unit 210 including a keyboard and a pointing device. A display control unit 207 controls display to a display unit 211. A disk controller 208 has access to an HDD 212 or the like that stores a boot program, various types of applications, font data, and the like. A network controller 213 is connected to a network, and executes communication control processing with another device connected to the network. A bus 204 connects the CPU 201 to the RAM 202, the ROM 203, and various controllers and the like, and carries data signals and control signals.

When the information processing apparatus 102 is a portable terminal, a touch panel controller or the like may be provided in place of the operation control unit 206. Further, the internal configuration of the network controller 213 may vary depending on whether the system includes a wired LAN or a wireless LAN, or both a wired LAN and a wireless LAN. However, differences due to these internal configurations are hidden in the network controller 213, and the network controller 213 is configured to control the system as an equivalent network controller to the other modules shown in FIG. 2.

In the present embodiment, the information processing apparatus 104 is described as having the same configuration as that of the information processing apparatus 102. However, in the present embodiment, the colorimeter 107 is connected to the information processing apparatus 102, but is not connected to the information processing apparatus 104. The information processing apparatus 104 and the information processing apparatus 102 are not limited to the configuration shown in FIG. 2, and may have configurations corresponding to the functions that can be executed by devices applied as the apparatuses as necessary.

In the present embodiment, the information processing apparatus 104 holds software for using a remote user interface (remote UI). Such software functions as a Web server. Accordingly, as a result of the information processing apparatus 102 accessing the Web server of the information processing apparatus 104 using a Web browser, a remote UI screen is displayed in the display unit 211 of the information processing apparatus 102. The software includes a front end that performs controls display of the Web browser of the information processing apparatus 102 and the like, and a back end. The front end manages/holds a program (JavaScript) executed on the Web browser, and is transmitted (downloaded), for example, to the information processing apparatus 102, whereby the corresponding display performed on the Web browser of the information processing apparatus 102. The front end includes, for example, a program for performing user authentication. In a state in which the program of the front end is downloaded to the information processing apparatus 102, that program constitutes a part of the software configuration of the information processing apparatus 102.

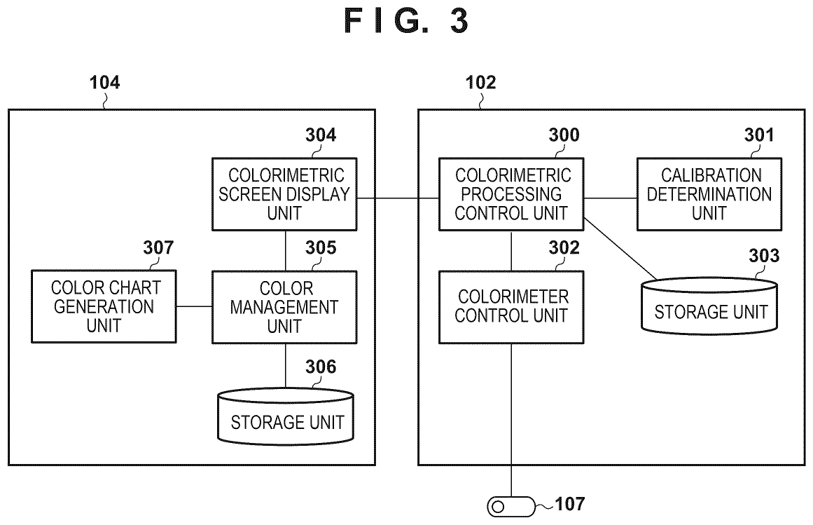

FIG. 3 is a diagram showing a functional block configuration of the system in the information processing apparatuses 102 and 104. The information processing apparatus 102 includes a colorimetric processing control unit 300, a calibration determination unit 301, a colorimeter control unit 302, and a storage unit 303. The colorimetric processing control unit 300 communicates with a color management unit 305 via a colorimetric screen displayed by a colorimetric screen display unit 304 of the information processing apparatus 104 to control various types of colorimetric processing. Specifically, for example, the colorimetric processing control unit 300 communicates with the color management unit 305 by accessing the information processing apparatus 104 using a remote UI.

The calibration determination unit 301 receives a set value and a colorimetric value from the colorimetric processing control unit 300, and determines whether or not calibration of the colorimeter 107 is needed. The set value includes the reference value of each patch of a color chart, the page count, the numbers of rows and columns, and so forth of the color chart. The set value may be held in the storage unit 303. The calibration determination unit 301 may obtain the set value held in the storage unit 306 of the information processing apparatus 104, using the remote UI via the colorimetric screen displayed by the colorimetric screen display unit 304.

Continuous use of the colorimeter will cause degradation of the performance of an optical sensor in the colorimeter due to aging. This results in a deviation between the reference value and the measured value of the white reference plate. Accordingly, calibration of the colorimeter 107 is needed. Calibration of the colorimeter 107 is processing for correcting a deviation between the reference value and the measured value of the white reference plate. In the calibration processing of the colorimeter 107, the magnitude of the deviation can be known by comparing the reference value and the measured value of the white reference plate. Accordingly, the optical sensor is corrected in the colorimeter by that magnitude toward the reference value. Thus, the deviation is modified. Note that a white reference plate is an attachment attached at the time of purchase of a colorimeter, and serves as a calibration reference when performing measurement by the colorimeter. As an operation of calibration of the colorimeter 107, for example, for a manual colorimeter, the colorimeter is set on a white reference plate used for adjustment of the colorimeter, and a colorimetry button of the colorimeter is pressed and held, whereby calibration of the colorimeter 107 is performed.

The colorimeter control unit 302 functions as a communication control interface for controlling communication with the colorimeter 107. For example, the colorimeter control unit 302 instructs the colorimeter 107 to execute calibration, instructs the colorimeter 107 to perform colorimetry, and receives a colorimetric value from the colorimeter 107. The storage unit 303 holds set values and colorimetric values required for colorimetric processing.

The information processing apparatus 104 includes a colorimetric screen display unit 304, a color management unit 305, a storage unit 306, and a color chart generation unit 307. For example, the colorimetric screen display unit 304 displays, in the display unit 211 of the information processing apparatus 102, a screen showing a colorimetric operation procedure for a color chart using the colorimeter 107. The color management unit 305 manages color management-related processing performed in the print system 103, including, for example, each calibration, profile creation, and so forth.

The image forming apparatus 106 is capable of executing printer calibration. Printer calibration is adjustment of CMYK densities or CMYK tones in order to enable the image forming apparatus 106 to reproduce target colors on a sheet defined as a standard. CMYK are examples of colors that can be printed by the image forming apparatus 106, and represent cyan (C), magenta (M), yellow (Y), and black (K). Although, in the present embodiment, CMYK are described as colors that can be printed by the image forming apparatus 106, other colors such as light cyan and light magenta may be printable. CMYK densities or CMYK tones gradually change according to the printing amount and the elapsed time. Accordingly, in order to reproduce target colors, printer calibration needs to be periodically performed for the image forming apparatus 106.

The image forming apparatus 106 is capable of executing sheet calibration. Sheet calibration is adjustment for absorbing differences in tint and surface property for each sheet and thus outputting consistent colors, and is performed for each sheet. The adjustment is performed using, for example, a one-dimensional look-up table (1DLUT) that is set for each color of coloring material. The color and the surface property of sheets vary for each type. Therefore, when printing is performed with the same settings for all the sheets, colors change depending on the sheet, and colors that are close to the target cannot be realized. Thus, by performing sheet calibration for each sheet, colors that are output by the image forming apparatus 106 for each sheet are corrected so as to be close to the target, as a result of which colors close to the target can be realized consistently for each sheet.

Target colors cannot be reproduced on a sheet to be used in a state in which sheet calibration has not been performed for the sheet. Therefore, when sheet calibration has not been performed for a sheet to be used in color verification, the color verification may fail. Printer calibration is adjustment performed for a sheet defined as a standard, whereas sheet calibration is adjustment performed for each sheet. Since the surface property and the color appearance of a sheet to be used in printing vary depending on the type of the sheet, reproduced colors vary depending on the type of sheet. Accordingly, color quality adjustment and color verification need to be performed for each type of sheet.

The calibration performed by the print system 103 includes the above-described printer calibration and sheet calibration.

The color management unit 305 causes the image forming apparatus 106 to execute printing of a color chart required for color management. The storage unit 306 saves set values required for the processing executed by the color management unit 305. The color chart generation unit 307 generates color chart data according to an instruction from the color management unit 305.

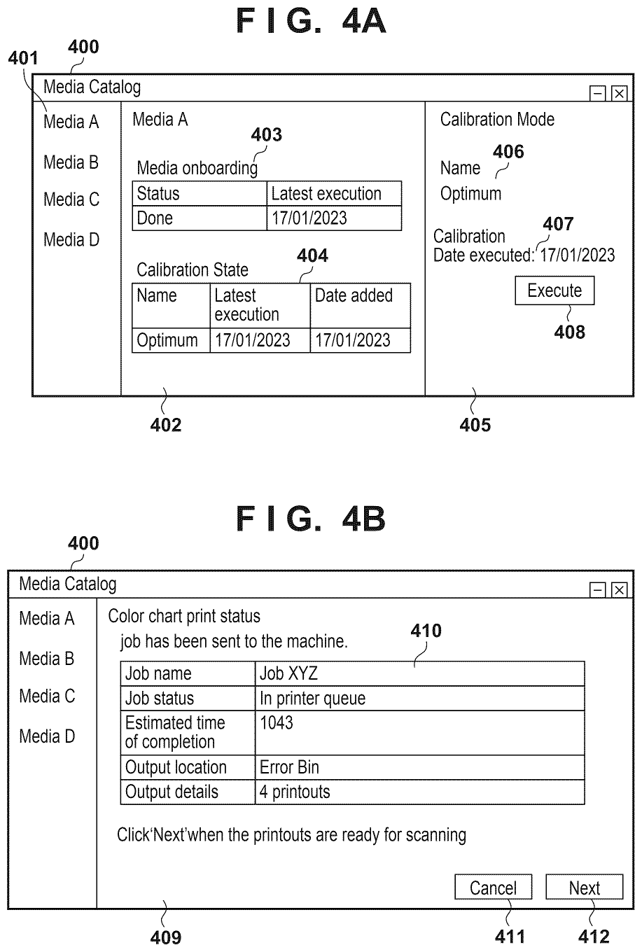

FIG. 4A is a diagram showing an example of a colorimetric screen displayed by the colorimetric screen display unit 304 of the information processing apparatus 104. A colorimetric screen 400 is displayed as a remote UI of a print controller that operates on the information processing apparatus 104. Specifically, for example, the colorimetric screen 400 is displayed by specifying a uniform resource locator (URL) of the print controller using a browser of the information processing apparatus 102.

The colorimetric screen 400 includes three sections. The colorimetric screen 400 includes a section of a sheet list 401. The sheet list 401 displays a list of sheets registered in the print controller. For example, the sheet list 401 displays a list of sheet types such as plain paper and glossy paper.

The colorimetric screen 400 includes a section of a detailed information screen 402 of a sheet selected in the sheet list 401. In this example, “Media A” is selected in the sheet list 401. Accordingly, the detailed information screen 402 displays detailed information of “Media A”. The detailed information screen 402 displays a feed tray loading state 403 of the sheet, and a calibration state 404 of the sheet.

The colorimetric screen 400 includes a section of a calibration execution instruction screen 405 for the sheet selected in the sheet list 401. The sheet calibration execution instruction screen 405 is displayed when the sheet calibration state 404 is selected. Then, when an execution button 408 has been pressed, sheet calibration is started. Specifically, for example, printing of a color chart for sheet calibration is started in the image forming apparatus 106. When the sheet calibration is started, the screen transitions to a screen shown in FIG. 4B. Note that when the sheet calibration is completed, an execution date 407 is updated. The calibration execution instruction screen 405 is provided with a name field 406 for giving a unique name to each sheet calibration state.

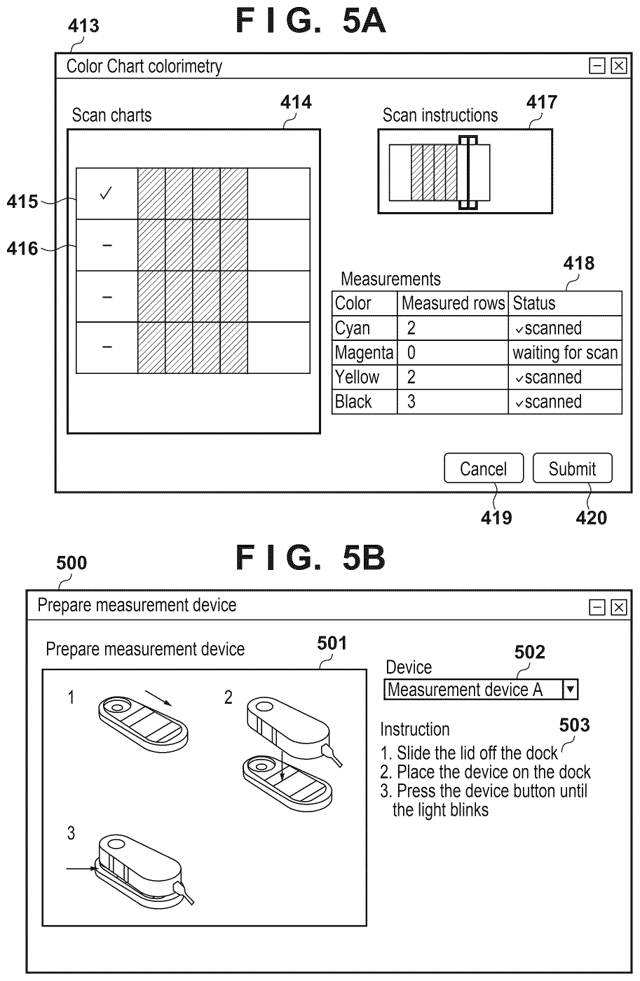

FIG. 4B is a diagram showing an example of a print screen of the color chart used for the sheet calibration. A color chart print status display screen 409 shows a print status of a color chart as a colorimetric target for which sheet calibration is to be performed. Detailed information 410 indicates a job name, a print status, a print completion time, an output tray, and detailed information about printing. When a Cancel button 411 has been pressed, printing is cancelled, and the screen transitions to the colorimetric screen 400 in FIG. 4A. A Next button 412 is activated when printing of the color chart is completed. When the Next button 412 has been pressed, the screen transitions to a color chart colorimetric screen 413 in FIG. 5A. In the present embodiment, at that time, when calibration of the colorimeter 107 is needed, a colorimeter calibration screen described below is displayed.

FIG. 5A is a diagram showing an example of a color chart colorimetric screen used for sheet calibration. A color chart colorimetric screen 413 includes a color chart colorimetric state 414, a scan instruction 417, a colorimetric state 418, a send button 420, and a cancel button 419. In the color chart colorimetric state 414, icons are displayed according to the respective colorimetric states of rows. For example, a measured icon 415 and an unmeasured icon 416 are displayed.

Immediately after the start of colorimetry of the color chart, all the rows are unmeasured, and therefore the unmeasured icons 416 are displayed. When colorimetry of a predetermined row has been finished, the row is now measured. Accordingly, the display changes from the unmeasured icon 416 to the measured icon 415. When colorimetry of the same row is performed many times, the measured icon 415 is kept displayed, and the number of times of colorimetry in a colorimetric state 418 described below increases.

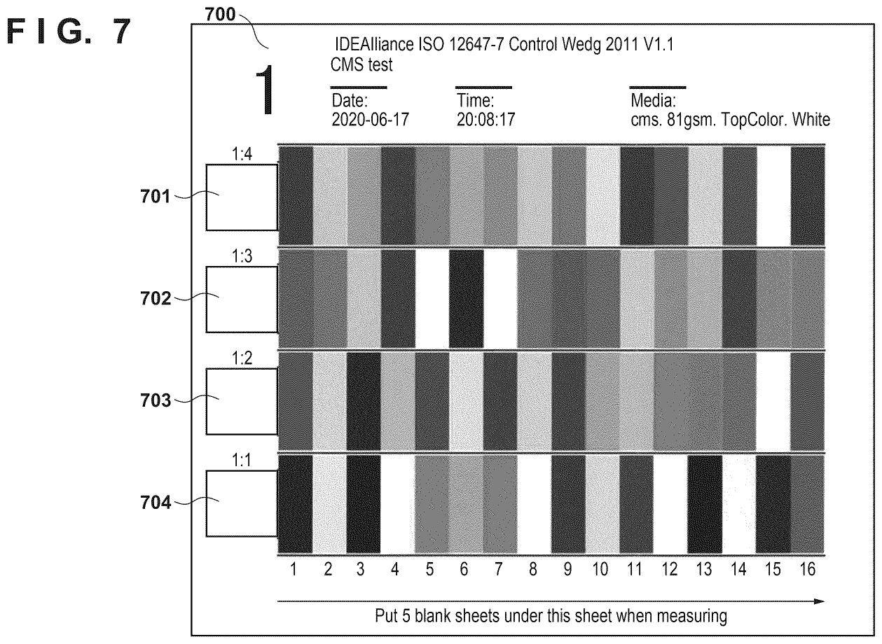

The scan instruction 417 displays a bar so as to prompt the user to move the colorimeter 107 on the row being measured, from right to left or left to right, according to the colorimetric operation of the colorimeter 107. The colorimetric state 418 displays the number of times of colorimetry and the colorimetric state for the color of each patch of the color chart. For example, in the case of the color chart shown in FIG. 7, when a predetermined row has been subjected to colorimetry, the number of times of colorimetry of the color representing the row increases. Then, the display of the colorimetric state changes from display indicating an unmeasured state (e.g., Waiting For Scan) to display indicating a measured state. When the send button 420 has been pressed, the colorimetric processing is completed, and a command to perform color management processing is activated in the print system 103. The color management processing is color verification, for example. When the cancel button 419 has been pressed, the colorimetric processing is terminated.

FIG. 5B is a diagram showing an example of an instruction screen to instruct the user to perform calibration of the colorimeter 107. A calibration instruction screen 500 is displayed if it is determined that a predetermined condition described below is satisfied when the color chart print status display screen 409 in FIG. 4B transitions to the color chart colorimetric screen 413 in FIG. 5A. Note that the calibration determination unit 301 performs determination as to whether or not the predetermined condition is satisfied.

Operation procedures 501 and 503 illustrate calibration procedures of the colorimeter 107 in the form of schematic diagrams and text. Display 502 displays the name of a colorimeter for which it is determined that calibration is needed. When only a single colorimeter is connected to the information processing apparatus 102, the colorimeter is displayed. When a plurality of colorimeters are connected to the information processing apparatus 102, only the names of colorimeters for which it is determined that calibration is needed are displayed. The schematic diagrams and the operation procedures displayed in the operation procedures 501 and 503 change according to the type of the colorimeter selected in the display 502.

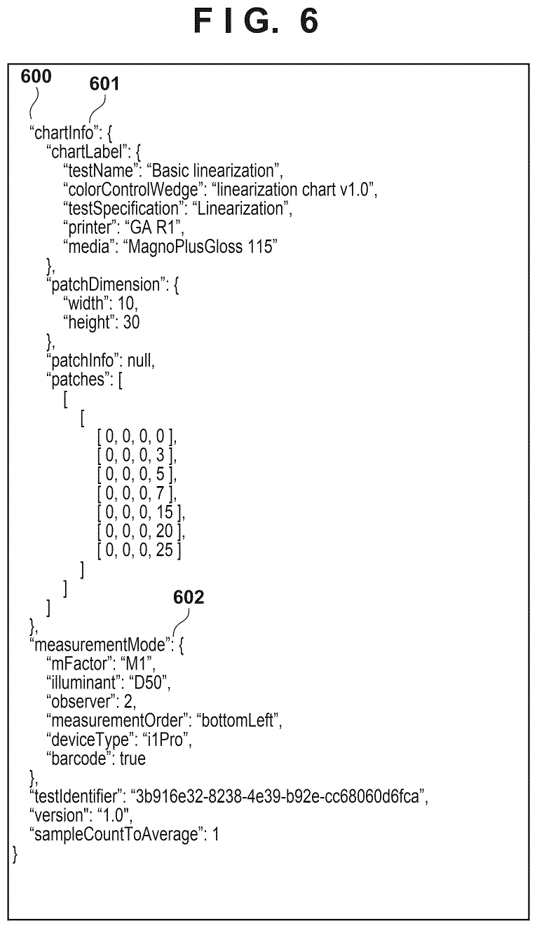

FIG. 6 is a diagram showing an example of data of a colorimetric condition when performing colorimetry of a color chart. Metadata 601 of a colorimetric condition 600 of a color chart is metadata of the color chart. For example, pieces of information such as the image forming apparatus that has printed the color chart, the sheet used for printing the color chart, and a job name are described in the metadata 601. A colorimetric setting 602 is a colorimetric setting. For example, an M factor (illumination condition of a colorimeter), an illuminant (light source), an observer (observer condition), a colorimetric direction, the type of a colorimeter, and so forth are described in the colorimetric setting 602.

The color chart colorimetric condition 600 is generated by the color management unit 305 of the information processing apparatus 104 when the Next button 412 has been pressed in the colorimetric screen 400, and is transmitted to the colorimetric processing control unit 300 of the information processing apparatus 102 by the colorimetric screen display unit 304. A color chart colorimetric condition may be provided in advance for each sheet, or the user may display a setting screen in which a colorimetric condition can be set, and a color chart colorimetric condition may be generated based on information received on the setting screen. Using the color chart colorimetric condition 600, the colorimetric processing control unit 300 sets up the colorimeter 107, and performs colorimetry of a color chart printed by the image forming apparatus 106.

The color chart colorimetric condition 600 is saved in the storage unit 303. After the colorimetry of the color chart, the colorimetric value obtained from the colorimeter 107 is saved in the storage unit 303 in association with the color chart colorimetric condition 600. The colorimetric value is saved as shown in Table 1. Table 1 indicates that three types of color chart colorimetric conditions are saved. Each of the colorimetric conditions is identifiable by identification information.

TABLE 1

| ID | Colorimetric Condition | Colorimetric Value |
|---|---|---|
| 1 | XXX.json | XXX.txt |
| 2 | YYY.json | YYY.txt |
| 3 | ZZZ.json | ZZZ.txt |

FIG. 7 is a diagram showing an example of a color chart printed by the image forming apparatus 106 when sheet calibration is performed. An area 700 shows the page count of the color chart. In this example, the page count 700 is “1” and therefore indicates the first page. Areas 701, 702, 703, and 704 are paper white areas provided in the respective rows of the color chart. A paper white area is mainly used for two uses. The first use is a use as the starting point of a row. The colorimeter 107 determines that loading of a row is started by recognizing a paper white area during reading. The second use is to determine whether or not calibration of the colorimeter 107 is needed. That is, if the measured value of a paper white area deviates from the reference value, it is determined that calibration of the colorimeter 107 is needed. Set values required to print the color chart are saved in the storage unit 306.

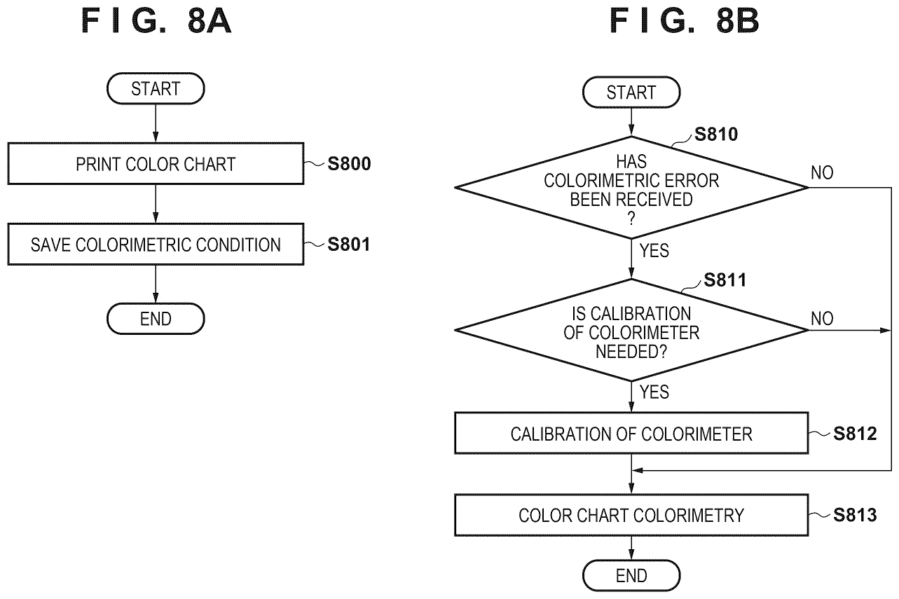

FIGS. 8A and 8B are flowcharts illustrating processing for controlling execution of calibration of the colorimeter 107. The processing of FIG. 8A is realized, for example, by the CPU 201 of the information processing apparatus 104 reading out a program stored in the ROM 203 to the RAM 202 and executing the program. The processing of FIG. 8A starts, for example, when the execution button 408 of the colorimetric screen 400 has been pressed. In the case of a system in which the information processing apparatus 102 and the information processing apparatus 104 are configured as a single device, FIGS. 8A and 8B can be implemented by a CPU of the single device reading out a program stored in a ROM to a RAM and executing the program.

In S800, the CPU 201 of the information processing apparatus 104 uses the color management unit 305 to execute printing of a color chart. Specifically, for example, the CPU 201 of the information processing apparatus 104 obtains color chart data generated by the color chart generation unit 307, and transmits the color chart data to the image forming apparatus 106. Then, for example, the color chart as shown in FIG. 7 is printed by the image forming apparatus 106.

In S801, the CPU 201 of the information processing apparatus 104 uses the color management unit 305 to transmit a color chart colorimetric condition 600 to the colorimetric processing control unit 300 of the information processing apparatus 102. The transmission of the color chart colorimetric condition 600 is performed, for example, when the Next button 412 of the colorimetric screen 400 has been pressed as described above.

The CPU 201 of the information processing apparatus 102 uses the colorimetric processing control unit 300 and the colorimeter control unit 302 to execute processing for setting up the colorimeter 107 based on the color chart colorimetric condition 600. For example, a screen that notifies a setup instruction of the colorimeter 107 may be displayed on the display unit 211 of the information processing apparatus 102. When an instruction to execute a setup of the colorimeter 107 is received on that screen, execution of the setup of the colorimeter 107 is started. When the setup of the colorimeter 107 is executed, the colorimetric processing control unit 300 obtains a colorimetric value of the white reference plate by the user pressing a button of the colorimeter 107. Then, the colorimetric processing control unit 300 saves the colorimetric value of the white reference plate in the storage unit 303 in association with the colorimetric condition 600 of the color chart. Then, the processing of FIG. 8B starts.

The processing of FIG. 8B is realized, for example, by the CPU 201 of the information processing apparatus 102 reading out the program stored in the ROM 203 to the RAM 202 and executing the program.

In S810, the CPU 201 of the information processing apparatus 102 uses the colorimetric processing control unit 300 to determine whether or not colorimetric error information has been received during execution of the setup of the colorimeter 107. If it is determined that the colorimetric error information has been received, the processing proceeds to S811. If it is determined that the colorimetric error information has not been received, the processing proceeds to S813.

In S811, the CPU 201 of the information processing apparatus 102 uses the calibration determination unit 301 to determine, based on the colorimetric error information received from the colorimeter 107, whether or not calibration of the colorimeter 107 is needed. Specifically, for example, the calibration determination unit 301 holds a determination table as shown in Table 2, and determines, according to the content of the colorimetric error information, whether or not calibration of the colorimeter 107 is needed.

TABLE 2

| Result Type | Category | Calibration needed? |
|---|---|---|
| eDeviceNotCalibrated | Type 1 | Yes |
| eRawValueTooLow | Type 2 | Yes |
| eRawValueTooHight | Type 2 | Yes |
| eDeviceAlreadyInUse | Type 3 | No |
| eDeviceCommunicationError | Type 3 | No |

For example, eDeviceNotCalibrated represents a state in which calibration of the colorimeter 107 has not been performed, or calibration of the colorimeter 107 has been performed, but a predetermined period has elapsed (an expiration period has passed). The calibration determination unit 301 determines that calibration of the colorimeter 107 is needed instantly if the error type represented by the colorimetric error information received from the colorimeter 107 is Type 1.

eRawValueTooLow represents a state in which, as a result of placing a colorimeter on a white reference plate and obtaining a colorimetric value of the white reference plate, the colorimetric value is excessively lower than the expected value. On the other hand, eRawValueTooHigh represents a state in which, as a result of obtaining a colorimetric value of the white reference plate, the colorimetric value is excessively higher than the expected value. During execution of the setup of the colorimeter 107, the error type represented by the colorimetric error information received from the colorimeter 107 may be Type 2 when a colorimetric value of the white reference plate is obtained by the user pressing a button of the colorimeter 107. In that case, the calibration determination unit 301 checks if the Type 2 colorimetric error occurred many times in the past, and determines that calibration of the colorimeter 107 is needed if the number of times of the occurrence exceeds a predefined threshold.

eDeviceAlreadyInUse represents a state in which the colorimeter is already in use by another application. eDeviceCommunicationError represents a state in which communication cannot be established with the colorimeter 107. Accordingly, even if calibration of the colorimeter 107 is performed, the problems thereof cannot be solved. The calibration determination unit 301 determines that calibration of the colorimeter 107 is not needed if the error type indicated by the colorimetric error information received from the colorimeter 107 is Type 3.

If it is determined in S811 that calibration of the colorimeter 107 is needed, the processing proceeds to S812. If it is determined in S811 that calibration of the colorimeter 107 is not needed, the processing proceeds to S813.

In S812, the CPU 201 of the information processing apparatus 102 uses the colorimetric processing control unit 300 and the colorimeter control unit 302 to execute calibration of the colorimeter 107. The calibration of the colorimeter 107 differs according to the type of the colorimeter. For example, when the colorimeter 107 is a manual colorimeter, the screen as shown in FIG. 5 is displayed to prompt the user to perform calibration. For example, when the colorimeter 107 is an automatic colorimeter, the calibration of the colorimeter 107 is automatically executed without any user operation.

In S813, the CPU 201 of the information processing apparatus 102 uses the colorimetric processing control unit 300 to obtain a colorimetric result of the color chart printed in S800. The colorimetric value of the color chart that has been subjected to colorimetry by the colorimeter 107 is transmitted to the colorimetric processing control unit 300 via the colorimeter control unit 302. The colorimetric processing control unit 300 saves the colorimetric value in the storage unit 303 in association with the colorimetric condition 600 of the color chart.

As described above, when colorimetry of a color chart is performed in sheet calibration, the present embodiment allows calibration of a colorimeter to be executed at an appropriate timing, based on colorimetric error information received from the colorimeter.

### Second Embodiment

The second embodiment will be described below, focusing on differences from the first embodiment. In the first embodiment, a configuration has been described in which whether or not calibration of the colorimeter 107 is needed is determined according to the colorimetric error information received from the colorimeter 107. Here, a case is envisaged where sheet calibration is successively performed in the print system 103. For example, there is a case where printed materials composed of a plurality of sheets, such as books, are produced. In such a case, calibration of the colorimeter 107 need not be performed each time. Rather, calibration of the colorimeter 107 need only be performed when the performance of the colorimeter 107 has degraded. Accordingly, in the present embodiment, whether or not to perform calibration of the colorimeter 107 is determined based on the actual variations in the colorimetric values.

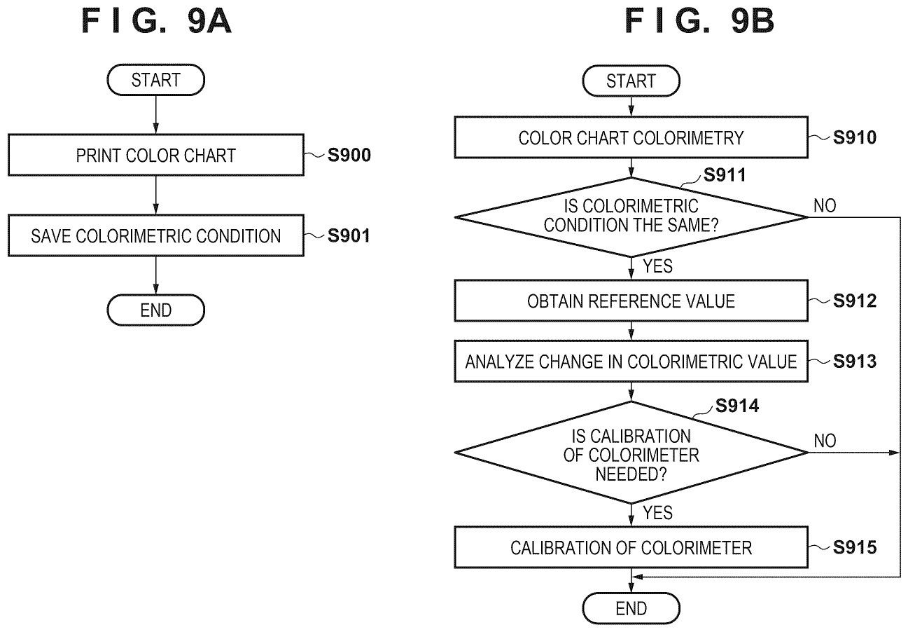

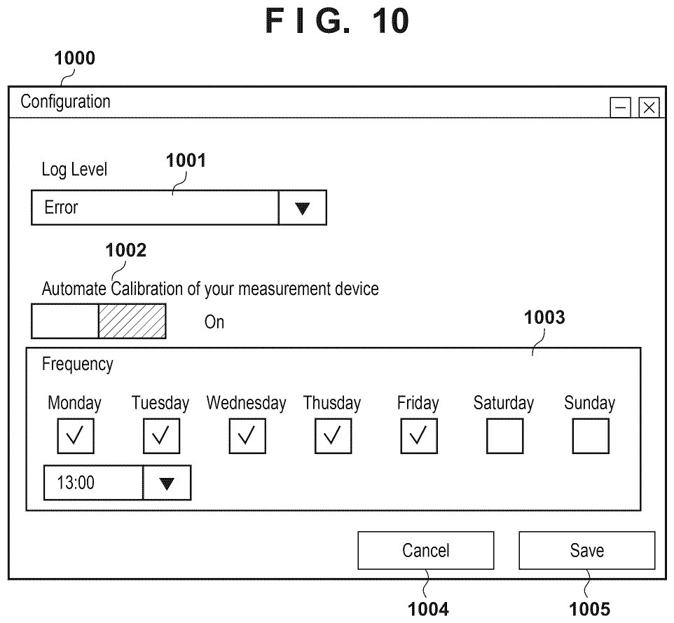

FIGS. 9A and 9B are flowcharts illustrating processing for calibration of the colorimeter 107. The processing of FIG. 9A is realized, for example, by the CPU 201 of the information processing apparatus 104 reading out the program stored in the ROM 203 to the RAM 202 and executing the program. The processing of FIG. 9A starts, for example, when the execution button 408 of the colorimetric screen 400 has been pressed. The processing of S900 and S901 is the same as the processing of S800 and S801 of FIG. 8, and therefore the description thereof has been omitted. In the case of a system in which the information processing apparatus 102 and the information processing apparatus 104 are configured as a single device, FIGS. 9A and 9B can be implemented by a CPU of the single device reading out a program stored in a ROM to a RAM and executing the program.

FIG. 9B is a flowchart illustrating processing for calibration of the colorimeter 107. The processing of FIG. 9B is realized, for example, by the CPU 201 of the information processing apparatus 102 reading out the program stored in the ROM 203 to the RAM 202 and executing the program. Note that the processing of S910 to S915 using paper white areas on the color chart is repeatedly executed each time a paper white area is measured by the colorimeter 107.

In S910, the CPU 201 of the information processing apparatus 102 uses the colorimetric processing control unit 300 and the colorimeter control unit 302 to cause the colorimeter 107 to execute colorimetry of the color chart. As shown in FIG. 7, the colorimetry of the color chart is performed for each row. A paper white area is provided at the left end of each row, and the paper white area is subjected to colorimetry each time colorimetry is performed on the row. The colorimetric processing control unit 300 saves the colorimetric value resulting from the colorimetry in the storage unit 303.

In S911, the CPU 201 of the information processing apparatus 102 uses the colorimetric processing control unit 300 to retrieve the color chart colorimetric condition 600 saved in the storage unit 303, and determine whether or not the same colorimetric condition as that of the colorimetric condition of the color chart that is currently being subjected to colorimetry exists. Examples of the colorimetric conditions used for the determination include information such as the image forming apparatus that has printed the color chart, the sheet used when printing the color chart, and a job name. Examples of the colorimetric conditions used for the determination also include an M factor (illumination condition of the colorimeter), an illuminant (light source), an observer (observer condition), a colorimetric direction, and the type of the colorimeter. If it is determined in S911 that the same colorimetric condition exists, the processing proceeds to S912. If it is determined that the same colorimetric condition does not exist, the processing of FIG. 9 ends. Note that colorimetric conditions 600 stored in the past are accumulated in the storage unit 303.

In S912, the CPU 201 of the information processing apparatus 102 uses the colorimetric processing control unit 300 to obtain a reference value for analyzing the change in colorimetric value. As the reference value, the colorimetric value of a white plate used when performing calibration of the colorimeter 107 is used. Since the colorimetric value may deviate from the reference value depending on the colorimetric condition such as the sheet or light source used, such deviation is corrected according to the colorimetric condition during setup. For example, the value of paper white obtained in the past at the time of shipment from the factory by colorimetry performed under the same colorimetric condition may also be used as the reference value.

In S913, the CPU 201 of the information processing apparatus 102 uses the calibration determination unit 301 to analyze the change in colorimetric value. Specifically, for example, the CPU 201 of the information processing apparatus 102 compares the reference value obtained in S912 with the colorimetric value of the paper white area that has been subjected to colorimetry in S910.

In S914, the CPU 201 of the information processing apparatus 102 uses the calibration determination unit 301 to determine whether or not the difference between the reference value and the colorimetric value exceeds a threshold, based on the result of the comparison in S913. Then, if it is determined that the threshold is exceeded, the CPU 201 of the information processing apparatus 102 determines that calibration of the colorimeter 107 is needed. On the other hand, if it is determined that the threshold is not exceeded, the CPU 201 of the information processing apparatus 102 determines that calibration of the colorimeter 107 is not needed. Here, the limit number of times that the colorimetric value exceeds the threshold may be set, and it may be determined that calibration of the colorimeter 107 is needed if the limit number is reached. If it is determined that the colorimetric value exceeds the threshold once, this may be an error. By setting the limit number of times that the colorimetric value exceeds the threshold to be plural, the timing at which calibration of the colorimeter 107 is needed can be appropriately determined. If it is determined that calibration of the colorimeter 107 is needed, the processing proceeds to S915. If it is determined that calibration of the colorimeter is not needed, the processing of FIG. 9 ends.

In S915, the CPU 201 of the information processing apparatus 102 uses the colorimetric processing control unit 300 and the colorimeter control unit 302 to execute processing for calibration of the colorimeter 107. The calibration of the colorimeter 107 differs according to the type of the colorimeter. For example, when the colorimeter 107 is a manual colorimeter, the screen as shown in FIG. 5 is displayed to prompt the user to perform calibration. For example, when the colorimeter 107 is an automatic colorimeter, the calibration of the colorimeter 107 is executed without any user operation.

As described above, according to the present embodiment, based on the variations in colorimetric value of the paper white area that has been transmitted from the colorimeter 107, it is determined that calibration of the colorimeter 107 is needed if the variations in colorimetric value of the paper white areas serving as a reference are significant. Such a configuration allows calibration of the colorimeter to be executed at an appropriate timing.

### Third Embodiment

The third embodiment will be described below, focusing on differences from the first and second embodiments. In the first embodiment, a configuration has been described in which whether or not calibration of the colorimeter 107 is needed is determined according to the colorimetric error information received from the colorimeter 107. In the second embodiment, a configuration has been described in which whether or not calibration of the colorimeter 107 is needed is determined according to the variations in colorimetric value of the paper white areas of the color chart. Here, for example, there may be a case where it is desirable to perform calibration of the colorimeter 107 at a certain time. Accordingly, in the present embodiment, calibration of the colorimeter 107 is executed at a designated time.

FIG. 10 is a diagram showing an example of a setting screen displayed in the colorimetric system 101 for setting the execution timing of calibration of the colorimeter 107. A setting screen 1000 shown in FIG. 10 is displayed by the display unit 211 of the information processing apparatus 102. A setting 1001 is an area for setting the log level of a log generated by the colorimetric system 101. A setting 1002 is an area for setting whether or not to perform calibration of the colorimeter 107 at a predetermined time. When this setting is ON, calibration of the colorimeter 107 is performed according to the setting details defined in a setting 1003. The setting 1003 is an area for setting the timing at which calibration of the colorimeter 107 is performed. In the present embodiment, it is possible to set, for example, a day of the week and a time. When a cancel button 1004 has been pressed, the value set on the setting screen 1000 is discarded, and the setting screen 1000 closes. When a save button 1005 has been pressed, the set value is saved, and the colorimetric system 101 operates according to the setting.

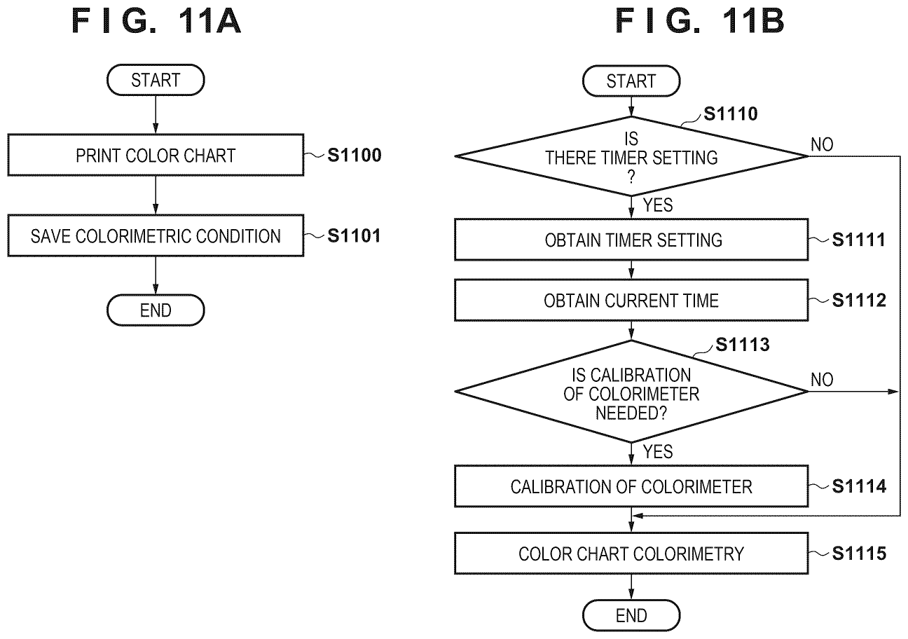

FIGS. 11A and 11B are flowcharts illustrating processing for calibration of the colorimeter 107. The processing of FIG. 11A is realized, for example, by the CPU 201 of the information processing apparatus 104 reading out the program stored in the ROM 203 to the RAM 202 and executing the program. The processing of FIG. 11A starts, for example, when the execution button 408 of the colorimetric screen 400 has been pressed. Since the processing of S1100 and S1101 is the same as the processing of S800 and S801 of FIG. 8, the description thereof has been omitted. In the case of a system in which the information processing apparatus 102 and the information processing apparatus 104 are configured as a single device, FIGS. 11A and 11B can be implemented by a CPU of the single device reading out a program stored in a ROM to a RAM and executing the program.

The processing of FIG. 11B is realized, for example, by the CPU 201 of the information processing apparatus 102 reading out the program stored in the ROM 203 to the RAM 202 and executing the program.

In S1110, the CPU 201 of the information processing apparatus 102 uses the colorimetric processing control unit 300 to determine whether or not a timer setting for performing calibration of the colorimeter 107 is ON. Specifically, for example, the colorimetric processing control unit 300 determines whether or not the setting in the setting 1002 shown in FIG. 10 is ON. If it is determined that the timer setting is ON, the processing proceeds to S1111. If it is determined that the timer setting is OFF, the processing proceeds to S1115.

In S1111, the CPU 201 of the information processing apparatus 102 uses the calibration determination unit 301 to obtain the timer setting. Specifically, for example, the set value (setting information) set in the setting 1003 shown in FIG. 10 is obtained. In S1112, the CPU 201 of the information processing apparatus 102 uses the calibration determination unit 301 to obtain the current time (including date information) of the information processing apparatus 102.

In S1113, the CPU 201 of the information processing apparatus 102 uses the calibration determination unit 301 to determine whether or not to perform calibration of the colorimeter 107. Specifically, for example, the CPU 201 of the information processing apparatus 102 determines whether or not the current time obtained in S1112 satisfies the timer setting condition obtained in S1111. For example, when the timer is set at 13:00 on Thursday, and the current time is 14:00 on Thursday, the calibration determination unit 301 determines that calibration of the colorimeter 107 is needed to be performed. For example, when the timer is set at 13:00 on Thursday, and the current time is 12:00 on Thursday, the calibration determination unit 301 determines that calibration of the colorimeter 107 is not needed to be performed. A permissible value may be set for the timer setting, and it may be determined that calibration of the colorimeter 107 is needed to be performed if the time difference is within the permissible value. For example, in a case where the timer is set at 13:00 on Thursday, and the permissible value is 15 minutes, the calibration determination unit 301 determines that calibration of the colorimeter 107 is needed to be performed if the current time is 12:50 on Thursday. If it is determined that calibration of the colorimeter 107 is to be performed, the processing proceeds to S1114. If it is determined that calibration of the colorimeter 107 is not to be performed, the processing proceeds to S1115.

In S1114, the CPU 201 of the information processing apparatus 102 uses the colorimetric processing control unit 300 and the colorimeter control unit 302 to execute processing for calibration of the colorimeter 107. The calibration of the colorimeter 107 differs according to the type of the colorimeter. For example, when the colorimeter 107 is a manual colorimeter, the screen as shown in FIG. 5 is displayed to prompt the user to perform calibration. For example, when the colorimeter 107 is an automatic colorimeter, calibration of the colorimeter 107 is executed without any user operation.

In S1115, the CPU 201 of the information processing apparatus 102 uses the colorimetric processing control unit 300 to obtain a colorimetric result of the color chart printed in S1100. The colorimetric value of the color chart that has been subjected to colorimetry by the colorimeter 107 is transmitted to the colorimetric processing control unit 300 via the colorimeter control unit 302. The colorimetric processing control unit 300 saves the colorimetric value in the storage unit 303 in association with the colorimetric condition 600 of the color chart.

In the present embodiment, in a case where the timer setting conditions is reached immediately after colorimetry of the color chart, the calibration determination unit 301 may determine that calibration of the colorimeter 107 is needed to be performed immediately after colorimetry of the color chart. Then, the user may be prompted to perform calibration of the colorimeter 107. As described above, according to the present embodiment, in the case of performing calibration of the colorimeter 107 using a timer setting, it is determined that calibration of the colorimeter 107 is needed, based on the current time and the timer setting. Such a configuration allows calibration of the colorimeter to be executed at an appropriate timing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-027872, filed Feb. 27, 2024, which is hereby incorporated by reference herein in its entirety.

What is claimed is:

1. A control method executed in an information processing apparatus, the method comprising:
obtaining information relating to colorimetry from a colorimeter connected to the information processing apparatus; and
controlling, the colorimeter to execute calibration based on the obtained information relating to colorimetry.

2. The control method according to claim 1, wherein
the information relating to colorimetry includes error information.

3. The control method according to claim 2, wherein,
in the control, whether to cause the colorimeter to execute calibration is controlled based on an error type represented by the error information.

4. The control method according to claim 3, wherein,
when the error type is an error relating to a colorimetric result of a reference plate, the control is performed to cause the colorimeter to execute calibration.

5. The control method according to claim 3, wherein,
when the error type is an error relating to a period during which calibration of the colorimeter is not executed, the control is performed to cause the colorimeter to execute calibration.

6. The control method according to claim 3, wherein,
when the error type is an error relating to that the colorimeter is already in use, the control is performed to cause the colorimeter not to execute calibration.

7. The control method according to claim 3, wherein,
when the error type is an error relating to communication with the colorimeter, the control is performed to cause the colorimeter not to execute calibration.

8. The control method according to claim 1, wherein,
the information relating to colorimetry is obtained as a result of a setup of the colorimeter being performed.

9. The control method according to claim 1, wherein
the information relating to colorimetry includes information of a colorimetric result of a color chart for sheet calibration.

10. The control method according to claim 9, wherein
the colorimetric result of the color chart includes a colorimetric result of a paper white patch.

11. The control method according to claim 10, wherein,
the colorimeter is caused to execute calibration based on a result of comparison between the colorimetric result of the paper white patch and a reference value.

12. The control method according to claim 11, wherein
the comparison is performed for each of a plurality of times of sheet calibration.

13. The control method according to claim 12, wherein,
when a difference between the colorimetric result of the paper white patch and the reference value exceeds a threshold, the control is performed to cause the colorimeter to execute calibration.

14. The control method according to claim 13, wherein,
when the difference between the colorimetric result of the paper white patch and the reference value does not exceed the threshold, the control is performed to cause the colorimeter not to execute calibration until the difference exceeds the threshold.

15. The control method according to claim 12, wherein
the plurality of times of sheet calibration are executed under the same colorimetric condition.

16. The control method according to claim 1, further comprising obtaining setting information relating to an execution timing of calibration of the colorimeter, and,
when the setting information is obtained, whether to cause the colorimeter to execute calibration is controlled based on the setting information.

17. A non-transitory computer-readable storage medium that stores one or more programs including instructions, which when executed by one or more processors of an information processing apparatus, cause the information processing apparatus to:
obtain information relating to colorimetry from a colorimeter connected to the information processing apparatus; and
control, the colorimeter to execute calibration, based on the obtained information relating to colorimetry.

18. An information processing apparatus comprising:
at least one memory and at least one processor which function as:
an obtaining unit configured to obtain information relating to colorimetry from a colorimeter connected to the information processing apparatus; and,
a control unit configured to control, the colorimeter to execute calibration, based on the obtained information relating to colorimetry.
